(19) United States
(12) Patent Application Publication
(10) Pub. No.: US 2024/0351185 A1
(43) Pub. Date: Oct. 24, 2024

(54) FIREHOUSE TOOL RACK

(71) Applicant: Mid-Continent Custom LLC, Burrton, KS (US)

(72) Inventor: Dylan Neubauer, Burrton, KS (US)

(21) Appl. No.: 18/641,565

(22) Filed: Apr. 22, 2024

Related U.S. Application Data
(60) Provisional application No. 63/497,227, filed on Apr. 20, 2023.

(51) Int. Cl. B25H 3/04

(52) U.S. Cl. CPC B25H 3/04

(57) ABSTRACT

A tool rack for a firehouse is configured to hold fireman's tools in a way that facilitates quick access to the tools when responding to a fire, but which also keeps the tools tidy and organized until need for them arises. A frame supports the tool rack on a support structure such as a wall. The tool rack has distinct compartments for holding tools of various lengths. The tool rack has a short tool hanger configured to hang a plurality of short-length tools such as Halligans from the tool rack. The tool rack defines a long tool stand compartment configured to hold a plurality of long-length tools stood up vertically in the long tool stand compartment. The tool rack has a medium tool shelf compartment with horizontal tool shelves that are configured for holding one or more medium-length tools laid horizontally.

### CROSS-REFERENCE TO RELATED APPLICATIONS

This application claims the benefit of U.S. Provisional Patent Application Ser. No. 63/497,227, filed on Apr. 20, 2023, the entire contents of which are hereby incorporated by reference.

### FIELD

The present disclosure generally relates to tool racks, and more particularly to firehouse tool racks.

### BACKGROUND

Firemen require various tools including Halligans, New York roof hooks, axes, and sledgehammers. Typically, each fireman has an individual, dedicated set of tools stored at the firehouse. For example, a firehouse employing ten firemen might have ten different sets of various combinations of Halligans, New York roof hooks, axes, and sledgehammers. FIG. 1 shows how these tools are normally stored in a firehouse tool cache. The inventor believes that improvements can be made in the storage of fireman's tools at a firehouse.

### SUMMARY

Aspects of the present disclosure provide an improved firehouse tool rack for storing and organizing fireman tools.

In one aspect, a tool rack for a firehouse comprises a frame configured to support the tool rack on a support structure. A Halligan hanger is mounted on the frame. The Halligan hanger comprises a plate and at least one Halligan holder disposed on the plate. Each Halligan holder comprises a pike opening defined in the plate and a magnet mounted on the plate below the pike opening. Each Halligan holder is configured to receive the pike of a Halligan in the pike opening such that the Halligan hangs from the pike opening in front of the plate. The magnet is configured to releasably retain the Halligan in place when the Halligan hangs from the pike opening in front of the plate. The frame is configured to support the plate on the support structure such that the plate is spaced apart in front of the support structure and the tool rack defines a clearance space behind the plate for receiving the pike of the Halligan when the magnet holds the Halligan in front of the plate.

In another aspect, a tool rack for a firehouse comprises a short tool hanger configured to hang a plurality of short-length tools from the tool rack. A long tool stand compartment is configured to hold a plurality of long-length tools stood up vertically in the long tool stand compartment. A medium tool shelf compartment is between the short tool hanger and the long tool stand. The medium tool shelf compartment comprises a plurality of medium tool shelves. Each medium tool shelf is configured to hold one or more medium-length tools laid horizontally on the medium tool shelf.

### BRIEF DESCRIPTION OF THE DRAWINGS

FIG. 1 is an illustration of various tools leaned against a wall, representative of firehouse tool storage facilities of the prior art.

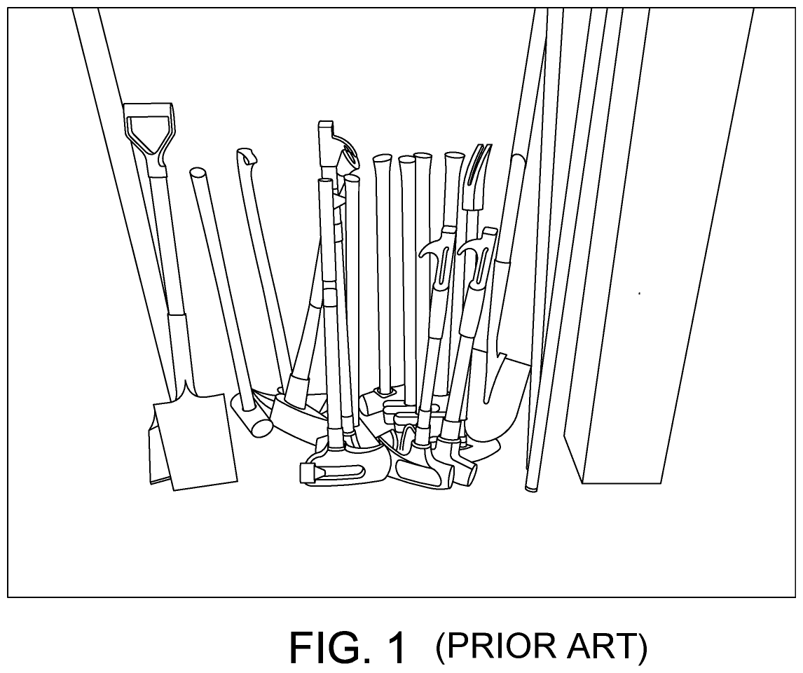

FIG. 2 is an illustration of a tool rack of this disclosure holding firehouse tools, according to an embodiment.

FIG. 3 is another illustration of the tool rack holding firehouse tools, according to an embodiment.

FIG. 4 is another illustration of the tool rack holding firehouse tools, according to an embodiment.

FIG. 5 is another illustration of the tool rack holding firehouse tools, according to an embodiment.

FIG. 6 is another illustration of the tool rack holding firehouse tools taken from the side, according to an embodiment.

FIG. 7 is another illustration of the tool rack holding firehouse tools, according to an embodiment.

FIG. 8 is an illustration of a portion of the tool rack including a Halligan hanger from which Halligans are hanging, according to an embodiment.

FIG. 9 is an illustration of a back view of an empty tool rack, according to an embodiment.

FIG. 10 is an illustration of a right view of an empty tool rack, according to an embodiment.

FIG. 11 is an illustration of a front view of an empty tool rack, according to an embodiment.

FIG. 12 is an illustration of an end view of a frame cleat, according to an embodiment.

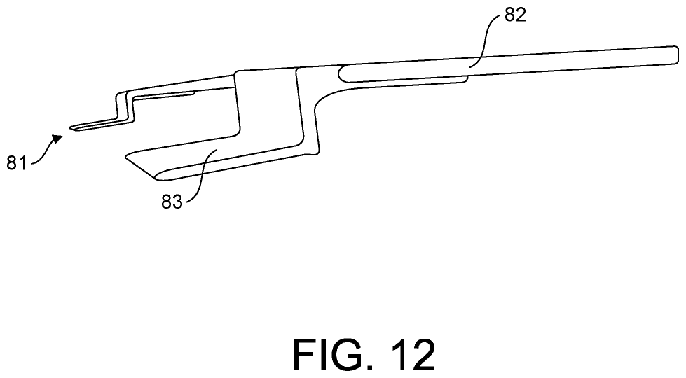

FIG. 13 is an illustration of a front view of a frame cleat, according to an embodiment.

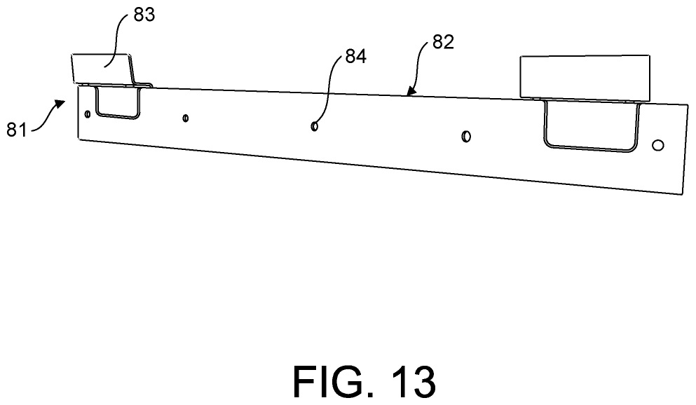

Corresponding parts are given corresponding reference characters throughout the drawings.

### DETAILED DESCRIPTION

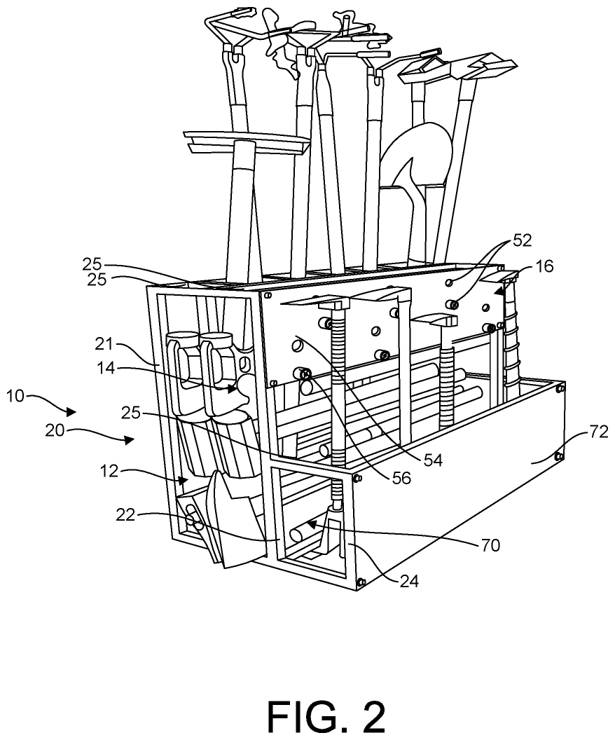

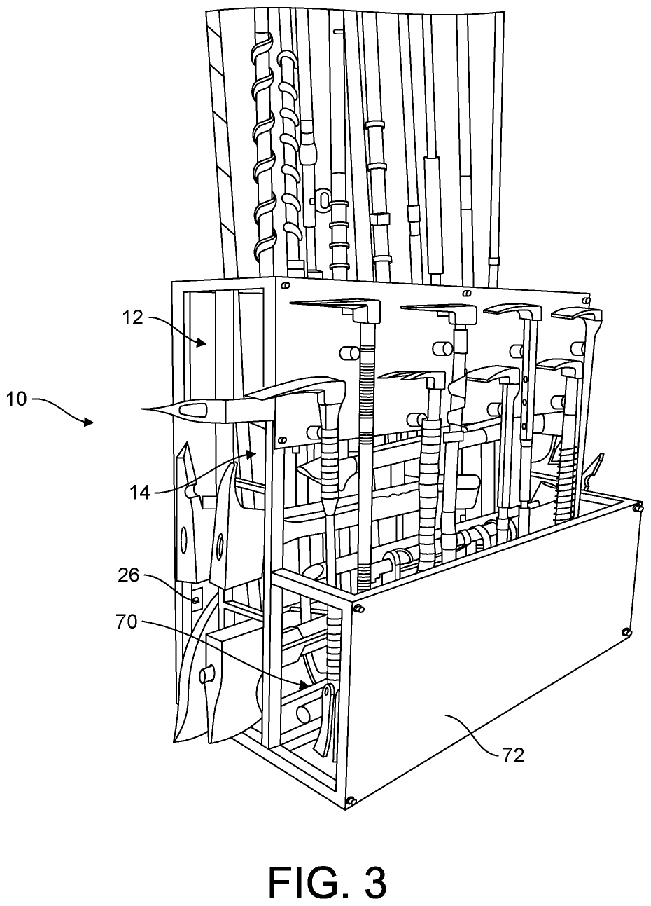

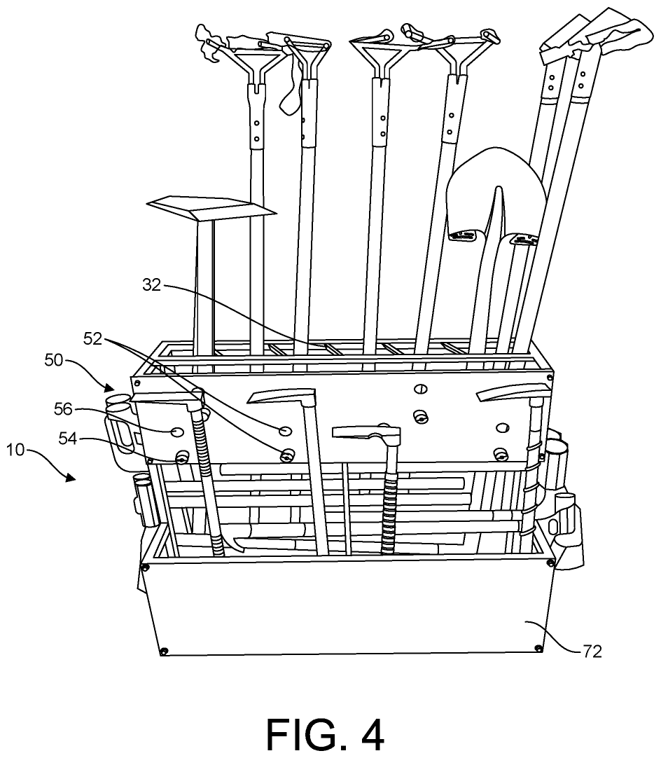

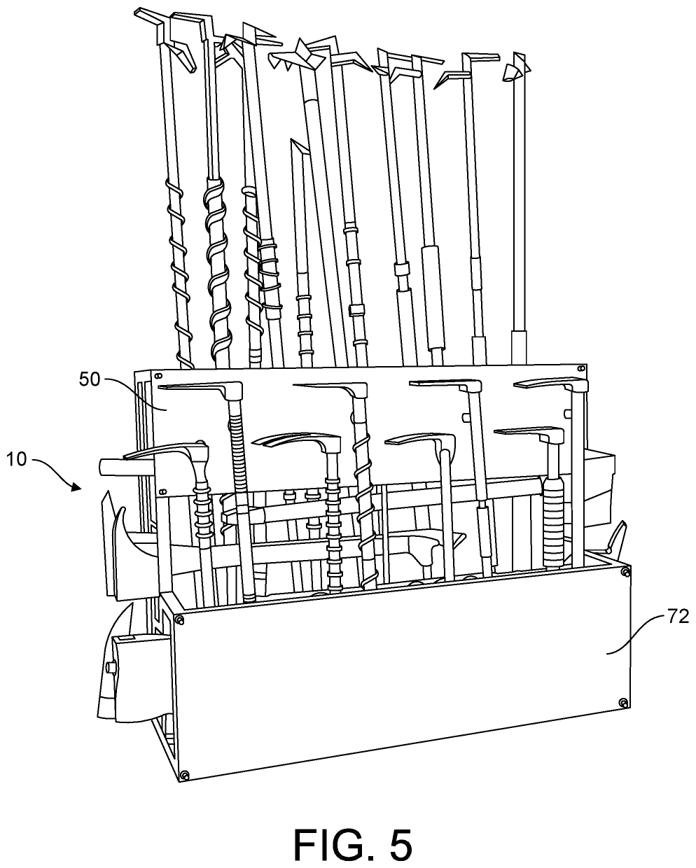

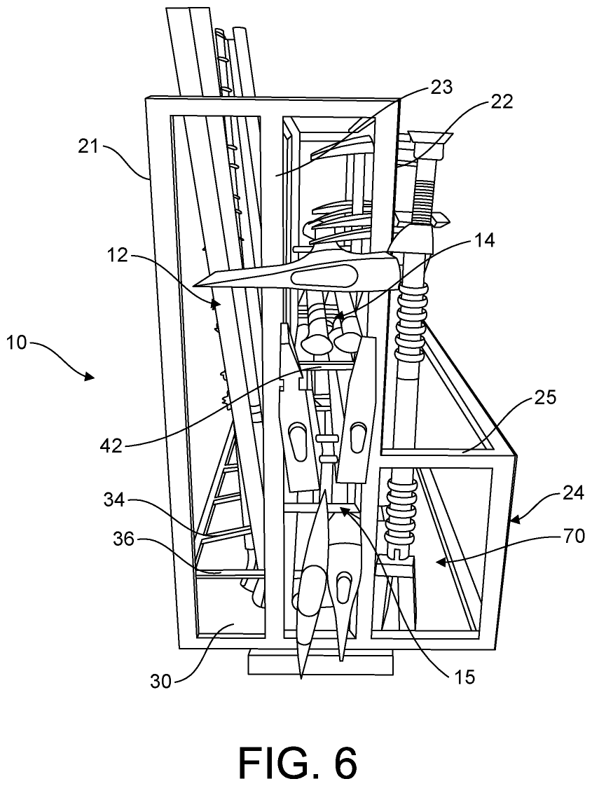

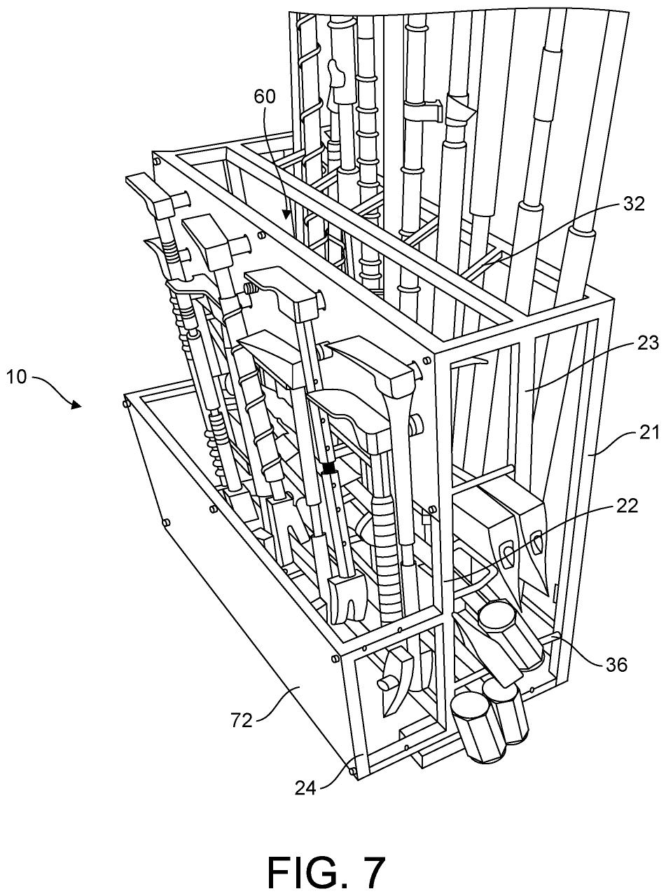

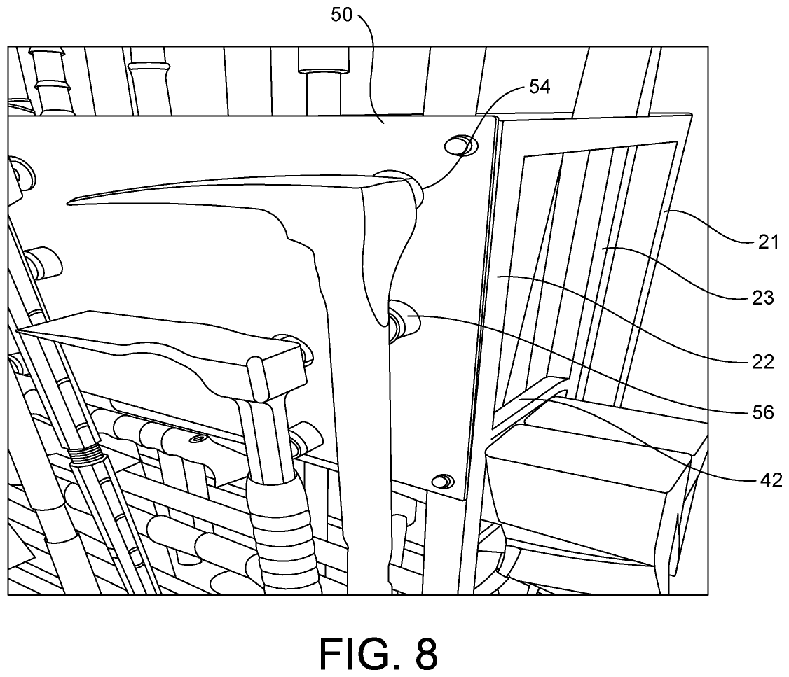

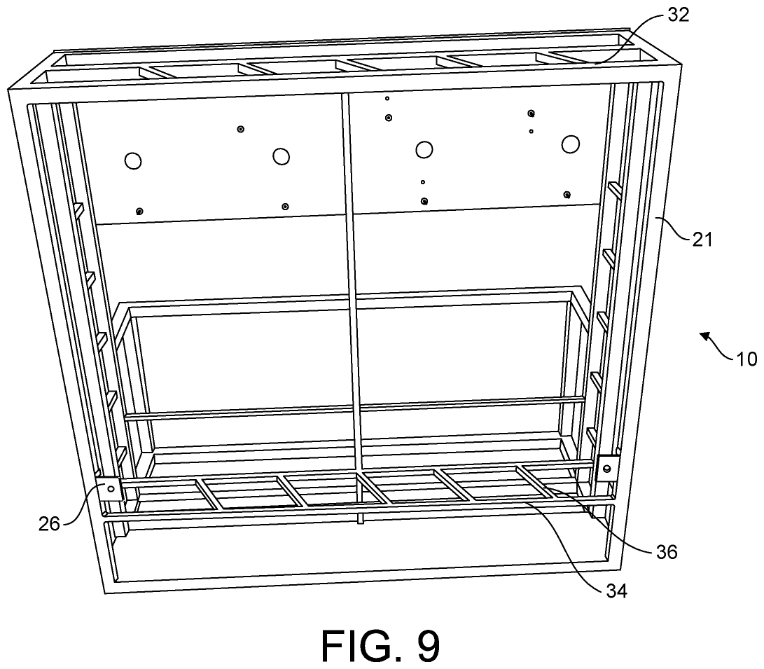

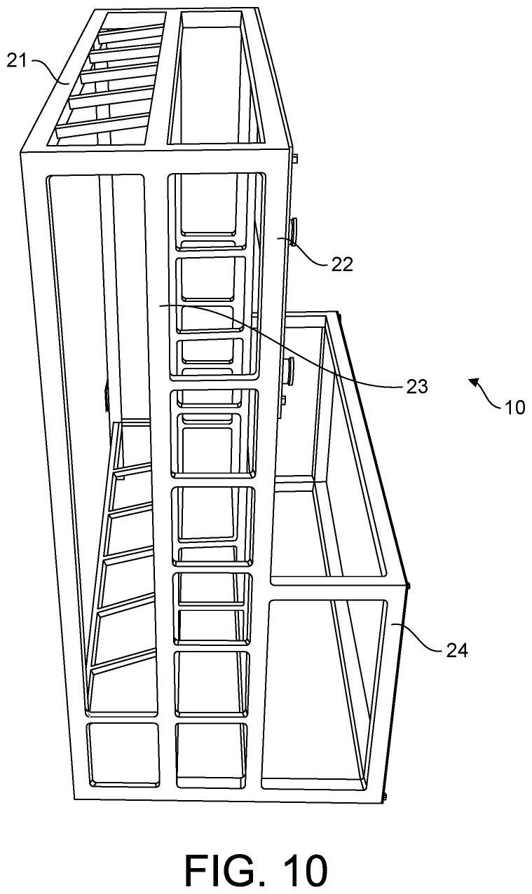

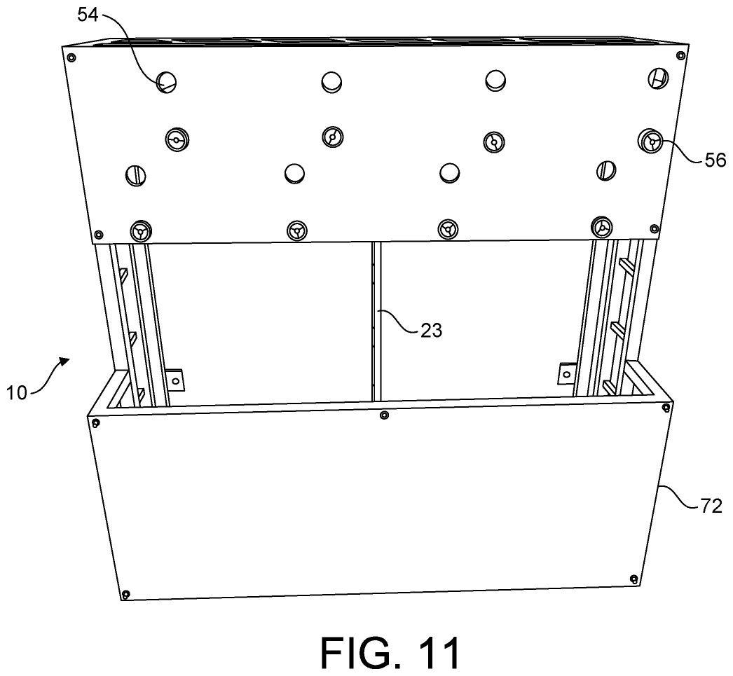

Referring to FIGS. 2-11, an exemplary embodiment of a tool rack for a firehouse is generally indicated at reference number 10. The firehouse tool rack is generally configured to hold fireman's tools at a firehouse in a way that facilitates quick access to the tools when responding to a fire, but which also keeps the tools tidy and organized until need for them arises. The illustrated firehouse tool rack 10 defines three distinct compartments for holding tools of various lengths. At the back of the unit, the rack 10 defines a long tool stand compartment 12 configured to hold a plurality of long-length tools (e.g., New York roof hooks or other tools with handles greater than 48 inches in length) stood up on end. In front of the long tool stand compartment 12, the tool rack 10 comprises a medium tool shelf compartment 14 with horizontal tool shelves 15 that are configured for holding one or more medium-length tools (e.g., axes, sledge hammers, or other tools with handles between 30 inches and 54 inches in length) laid horizontally. In front of the medium tool shelf compartment 14, the tool rack 10 comprises a Halligan hanger 16 (broadly, a short tool hanger) configured to hang a plurality of Halligans (broadly, short-length tools with handles of 36 inches in length or less).

The tool rack 10 comprises a frame 20 for supporting the tool rack on a support structure. In the illustrated embodiment, the frame 20 is a wall-mountable frame configured for mounting the tool rack 10 to a wall at an elevated position, where the entire tool rack is spaced apart above the ground. The inventor believes that elevating the tool rack 10 above the ground is advantageous because it allows firemen to sweep under the tool rack in accordance with common firehouse cleaning protocols. In the illustrated embodiment, the tool rack 10 has a width in an inclusive range of from 36 inches to 84 inches. The inventor believes that this range of widths advantageously provides ample tool storage capacity and enables the tool rack to be mounted on a wall in the main room of a firehouse (i.e., the room where the trucks are stationed) between two man doors in the main room spaced apart by the typical distance. In one or more embodiments, the tool rack 10 is configured to mount on the wall such that the front plane of the tool rack is spaced apart in front of the wall by a back-to-front spacing distance of less than 40 inches (e.g., less than or equal to 36 inches).

In the illustrated embodiment, the frame 20 is formed from welded metal tubing (e.g., square tubing). But it will be understood that the frame can be constructed from other materials and using other joining methods without departing from the scope of the present disclosure. In the illustrated embodiment, the frame includes a rectangular wall mount sub-frame 21 extending in a first (back) vertical plane, a rectangular hanger plate sub-frame 22 extending in a second (near-front) vertical plane spaced apart in front of the first vertical plane, a rectangular compartment divider sub-frame 23 extending in a third (middle) vertical plane spaced apart between the first vertical plane and the second vertical plane, and a kick plate sub-frame 24 extending in a fourth (front-most) vertical plane spaced apart in front of the second vertical plane. Each sub-frame 21, 22, 23, 24 comprises respective top, bottom, left, and right frame members. The left and right frame members of each sub-frame 21, 22, 23, 24 are located at the left and right ends of the tool rack 10. The bottom frame members of each sub-frames are located at the bottom end of the tool rack. The top frame members of the wall mount, compartment divider, and hanger plate sub-frames are located at the top end of the tool rack 10. By contrast, the kick plate sub-frame 24 is shorter such that the top frame member of the kick plate sub-frame is located along the lower half of the height of the tool rack 10. The tool rack 10 has a height extending from the bottom to the top of the tool rack, the height being in an inclusive range of from 36 inches to 60 inches.

The frame 20 further comprises at least one support member 25 extending in a back-to-front direction for holding the sub-frames 21, 22, 23, 24 together in their respective vertical planes. In the illustrated embodiment, the frame 20 comprises lower left and right support members connecting the lower left and right corners of the wall mount sub-frame 21 to the lower left and right corners of each of the compartment divider sub-frame 23, the hanger plate sub-frame 22, and the kick plate sub-frame 24. Rear upper left and right support members 25 connect the upper left and right corners of the wall mount sub-frame 21 to the upper left and right corners of the compartment divider sub-frame 23 and the plate hanger sub-frame 22. Upper kick plate support members 25 connect the upper left and right corners of the kick plate sub-frame 24 to the left and right frame members of the plate hanger sub-frame 22.

The wall mount sub-frame 21 defines a back side of the long tool stand compartment 12 and is configured to be fastened directly to an interior wall of the firehouse. In the illustrated embodiment, the tool rack 10 comprises screw plates 26 welded onto the wall mount sub-frame 21 that can be used to screw the tool rack top the wall.

The compartment divider sub-frame 23 defines a front side of the long tool stand compartment 12. Hence the long tool stand compartment 12 is located toward the rear of the tool rack 10, between the wall mount sub-frame 21 and the compartment divider sub-frame 23. The long tool stand compartment 12 comprises a bottom member 30 enclosing the bottom end of the compartment. The bottom member 30 is supported on the bottom frame members of the wall mount and compartment divider sub-frames 21, 23. The long tool stand compartment 12 is configured so that long tools can be stood up on end on the bottom member 30. In the illustrated embodiment, the long tool stand compartment 12 comprises a plurality of upper and lower divider bars 32, 34 for subdividing the tool stand compartment. The upper divider bars 32 extend from the top frame member of the wall mount sub-frame 21 to the top frame member of the compartment divider sub-frame 23. The lower divider bars 34 extend between lower crossbars 36 secured to sub-frames 21, 23 at height-wise locations adjacent to the bottom member 30. In one or more embodiments, the long tool stand compartment 15 has a front-to-back dimension in an inclusive range of from 6 inches to 18 inches.

The compartment divider sub-frame 23 defines a back side of the medium tool shelf compartment 14, and the plate hanger sub-frame 22 defines a front side of the medium tool shelf compartment. The tool shelves 15 are formed by pairs of left and right shelf bars 42 that extend in back-to-front directions between the left and right frame members of the compartment divider sub-frame 23 and the plate hanger sub-frame 22. The two shelf bars 42 in each shelf bar pair are located at the same location along the height of the tool rack. The plurality of pairs of shelf bars 42 are spaced apart along the tool rack height to define a plurality of horizontal tool shelves 15 at different heights. The horizontal tool shelves 15 can be formed in other ways without departing from the scope of the disclosure. In one or more embodiments, the medium tool shelf compartment 14 has a front-to-back dimension in an inclusive range of from 6 inches to 18 inches.

The Halligan hanger 16 is located in front the plate hanger sub-frame 22. It comprises a plate 50 secured to the upper portion the plate hanger sub-frame 22 and at least one Halligan holder 52 disposed on the plate. In the illustrated embodiment, there are a plurality of Halligan holders 52 spaced apart along the width of the plate. Each Halligan holder 52 comprises a pike opening 54 defined in the plate 50 and a magnet 56 mounted on the plate below the respective pike opening. Each Halligan holder 52 is configured to receive the pike of a Halligan in the pike opening 54 such that the Halligan hangs from the pike opening in front of the plate 50 The magnet 56 is configured to releasably retain the Halligan in place when the Halligan hangs from the pike opening 54 in front of the plate 50. For example, the illustrated magnets 56 magnetically adhere to the steel handles of the Halligans at locations shortly below the pikes and adze of the Halligans. The illustrated magnets 56 are positioned on the front side of the plate 50 and comprise neodymium.

It can be seen that the frame 20 is configured to support the plate 50 on the firehouse wall (broadly, support structure) such that the plate is spaced apart in front of the wall and the tool rack 10 defines a clearance space 60 behind the plate for receiving the pike of the Halligan. In the illustrated embodiment, the clearance space 60 is along the upper section of the horizontal tool shelf compartment 14, above the uppermost shelf 15 so that the Halligan pikes can be spaced apart above one or more medium-length tools supported horizontally on the uppermost shelf 15. This disclosure contemplates that the Halligan hanger 16 can also be used independently of the other features of the tool rack like the horizontal shelves 15 or stand up too compartment 12. Regardless of whether the Halligan hanger 16 is used independently or used in combination with other storage features of the tool rack 10, the frame 20 that holds the Halligan hanger plate 50 defines a clearance space 60 behind the plate sufficient to accommodate the length of the pike extended through the opening 54. For example, in one or more embodiments, the clearance space 60 has a front-to-back depth of at least 6 inches.

In the illustrated embodiment, the Halligan hanger 16 comprises a plurality of Halligan holders 52 arranged so that there is a set of upper Halligan holders and a set of lower Halligan holders spaced apart below the upper Halligan holders. The Halligan holders 52 are spaced apart along the plate 50 such that the upper and lower Halligan holders alternate along the width of the plate. The upper and lower Halligan holders 52 are positioned so that an adze of a Halligan held by one of the upper Halligan holders is spaced apart above a portion of the adze of a Halligan held by an adjacent lower Halligan holder in overlapping relation therewith.

The kick plate sub-frame 24 is spaced apart below the hanger plate 50 to define a lower compartment 70 for receiving the bottom forks of the Halligans suspended from the Halligan hanger 16. In one or more embodiments, the lower compartment 70 has a front-to-back dimension in an inclusive range of from 6 inches to 18 inches. A kick plate 72 formed from steel or other robust material is mounted on the kick plate sub-frame 24 in front of the lower compartment 70. The kick plate 72 covers the bottom forks of the Halligans and provides an aesthetically pleasing appearance. In one or more embodiments the kick plate 72 can be emblazoned with desired insignia, such as the firehouse number or logo to show company pride.

In one or more embodiments, a cleat 81 is used to secure the tool rack 10 onto a wall. The illustrated cleat 81 comprises a cleat mounting plate 82 and two or more mounting hangers 83. The cleat mounting plate 82 has a plurality of screw holes 84 used for screwing the frame cleat 81 into a wall. The mounting hangers 83 comprises L shaped brackets standing out from the plate 82 at spaced apart locations along the frame cleat 81.

The cleat 81 can be used to secure the tool rack 10 to a wall. First, the cleat 81 is screwed to the wall via the screw holes 84. Then the tool rack 10 is loosely suspended from cleat 81. In one embodiment, the top frame member of the wall mount sub-frame 21 is loaded into the mounting hangers 83 to suspend the tool rack 10 from the wall. To firmly secure the tool rack in place, it is screwed to the wall via the screw plates 26.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A tool rack for a firehouse, the tool rack comprising:
a frame configured to support the tool rack on a support structure;
a Halligan hanger mounted on the frame, the Halligan hanger comprising a plate and at least one Halligan holder disposed on the plate, each Halligan holder comprising a pike opening defined in the plate and a magnet mounted on the plate below the pike opening, each Halligan holder configured to receive the pike of a Halligan in the pike opening such that the Halligan hangs from the pike opening in front of the plate, the magnet configured to releasably retain the Halligan in place when the Halligan hangs from the pike opening in front of the plate;
wherein the frame is configured to support the plate on the support structure such that the plate is spaced apart in front of the support structure and the tool rack defines a clearance space behind the plate for receiving the pike of the Halligan when the magnet holds the Halligan in front of the plate.

2. The tool rack of claim 1, wherein the clearance space has a front-to-back depth of at least 6 inches.

3. The tool rack of claim 1, wherein the frame comprises a wall mount sub-frame configured to be secured to a wall, a hanger plate sub-frame configured to attach the plate, and at least one support member extending from the wall mount sub-frame to the hanger plate sub-frame for supporting the hanger plate sub-frame on the wall mount sub-frame at a location spaced apart in front of the wall mount sub-frame.

4. The tool rack of claim 3, wherein the frame further comprises a compartment divider sub-frame connected to at least one support member at a location between the wall mount sub-frame and the hanger plate sub-frame.

5. The tool rack of claim 4, wherein the tool rack comprises a long tool stand compartment between the compartment divider sub-frame and the wall holder sub-frame and a medium tool shelf compartment between the compartment divider sub-frame and the hanger plate sub-frame, the medium tool shelf compartment including a plurality of horizontal tool shelves, the clearance space being located above an uppermost one of the horizontal tool shelves.

6. The tool rack of claim 1, wherein the Halligan hanger comprises a plurality of Halligan holders including at least one upper Halligan holder and at least one lower Halligan holder, the Halligan holders being spaced apart along the plate such that the upper and lower Halligan holders alternate along the plate.

7. The tool rack of claim 6, wherein the upper and lower Halligan holders are positioned so that an adze of a Halligan held by one of the upper Halligan holders is spaced apart above a portion of the adze of a Halligan held by an adjacent lower Halligan holder in overlapping relation therewith.

8. The tool rack of claim 1, wherein the magnet is mounted on the front of the plate.

9. The tool rack of claim 1, wherein the magnet comprises neodymium.

10. The tool rack of claim 1, wherein the frame comprises a kick plate sub-frame in front of the Halligan hanger and the tool rack comprises a kick plate attached to the kick plate sub-frame.

11. The tool rack of claim 10, wherein the kick plate sub-frame is spaced apart below the plate of the Halligan hanger.

12. A tool rack for a firehouse, the tool rack comprising:
a short tool hanger configured to hang a plurality of short-length tools from the tool rack;
a long tool stand compartment configured to hold a plurality of long-length tools stood up vertically in the long tool stand compartment; and
a medium tool shelf compartment between the short tool hanger and the long tool stand, the medium tool shelf compartment comprising a plurality of medium tool shelves, each medium tool shelf configured to hold one or more medium-length tools laid horizontally on the medium tool shelf.

13. The tool rack of claim 12, wherein the short tool hanger comprises a Halligan hanger, the Halligan hanger comprising a plate and a plurality of Halligan holders disposed on the plate, each Halligan holder configured to releasably hold a Halligan so that the Halligan hangs from the plate.

14. The tool rack of claim 13, wherein each Halligan holder comprises a pike opening defined in the plate and configured to receive a pike of the Halligan, and wherein each Halligan holder comprises a magnet mounted on the plate below the pike opening and configured to releasably retain the Halligan in place.

15. The tool rack of claim 12, wherein the long tool stand compartment comprises a bottom member on which to stand up a long tool on end.

16. The tool rack of claim 12, wherein the tool rack is configured to be mounted on a wall at an elevated position.

17. The tool rack of claim 12, further comprising a frame including a wall mount sub-frame extending in a first vertical plane, a hanger plate sub-frame extending in a second vertical plane spaced apart in front of the first vertical plane, and a compartment divider sub-frame extending in a third vertical plane spaced apart between the first vertical plane and the second vertical plane.

18. The tool rack of claim 17, wherein the wall mount sub-frame defines a back side of the long tool stand compartment, the compartment divider sub-frame defines a front side of the long tool stand compartment and a back side of the medium tool shelf compartment, and the hanger plate sub-frame defines a front side of the medium tool shelf compartment, the short tool hanger comprising a hanger plate supported on a front side of the hanger plate sub-frame.

19. The tool rack of claim 17, wherein the long tool stand compartment is between the first and third vertical planes, the medium tool shelf compartment is between the third and second vertical planes, and the short tool hanger is configured to hang the plurality of short-length tools in front of the second vertical plane.

20. The tool rack of claim 17, wherein the frame further includes a kick plate sub-frame and a kick plate supported on the kick plate sub-frame, the kick plate sub-frame extending in a fourth vertical plane spaced apart in front of the second vertical plane, the short tool hanger configured to hang the plurality of short-length tools between the second vertical plane and fourth vertical plane.
